(19) United States
(12) Patent Application Publication
(10) Pub. No.: US 2025/0319437 A1
(43) Pub. Date: Oct. 16, 2025

(54) APPARATUS FOR DIRECT AIR CAPTURE OF CARBON DIOXIDE

(71) Applicant: Bal Mukund Dhar, Lincoln, MA (US)

(72) Inventor: Bal Mukund Dhar, Lincoln, MA (US)

(21) Appl. No.: 19/175,334

(22) Filed: Apr. 10, 2025

Related U.S. Application Data
(60) Provisional application No. 63/632,052, filed on Apr. 10, 2024.

(51) Int. Cl. B01D 53/62

(52) U.S. Cl. CPC B01D 53/62; B01D 2257/504

(57) ABSTRACT

A stand-alone apparatus for carbon dioxide capture is described. The apparatus comprises an air contactor having an inlet of air and an outlet of air, a sorbent for capture of CO₂ disposed inside the air contactor, and a wind turbine ventilator coupled to the air contactor, the motion of the wind turbine ventilator under the influence of wind causing the flow of air through the sorbent.

### CROSS-REFERENCE TO RELATED APPLICATIONS

This application is a Utility Patent application claiming priority to U.S. Provisional Patent Application Ser. No. 63/632,052, filed on Apr. 10, 2024, which is incorporated by reference herein in its entirety.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the disclosure, and the applicants, make no claim to any trademarks referenced.

### BACKGROUND OF THE DISCLOSURE

### 1) Field of the Disclosure

The disclosure relates to the field of Carbon Capture, and more specifically to Direct Air Capture, Direct Air Capture and Mineralization, Standalone Direct Air Capture Systems.

### 2) Description of Related Art

Direct Air Capture systems utilize structured or packed beds to facilitate intimate contact between air and CO₂ sorbents, promoting efficient mass transfer and capture of CO₂. Direct air contactor apparatus function based on the principle of gas-solid contact and mass transfer. The apparatus consists of a structured or packed bed filled with CO₂ sorbent material, which may be in the form of solid adsorbents, absorbents, or reactive solids. As ambient air flows through the contactor, CO₂ molecules in the air come into contact with the sorbent material, where they are selectively captured or reacted.

The sorbent material may chemically adsorb CO₂ molecules onto its surface, physically absorb CO₂ into its porous structure, or react with CO₂ to form stable compounds. The choice of sorbent material depends on factors such as CO₂ capture capacity, selectivity, regeneration properties, and compatibility with the operating conditions.

Several design considerations are important for the efficient operation of direct air contactor apparatus: sorbent selection, contactor geometry (structured adsorbents such as honeycomb monoliths, open-cell foams, or structured packing), airflow distribution, energy consumption, and temperature and humidity control:

Since the concentration of CO₂ in air is quite low (˜0.04%), large quantities of air need to be flown through the sorbent: around 2 million m³ per ton of CO₂ for a sorbent with high efficiency of absorption. Therefore, direct air contactors have high energy consumption which leads to high operational cost. There is a need for direct air contactors with low energy consumption. Further, there is a need to have standalone direct air contactors that can be deployed in remote areas.

### BRIEF SUMMARY OF THE DISCLOSURE

Embodiments described herein relate to an apparatus for carbon dioxide capture, the apparatus comprising: an air contactor having an air inlet and an air outlet; a sorbent for capture of CO₂ disposed inside the air contactor; and a wind force driven exhaust system coupled to the air contactor.

In some aspects, the motion of the wind force driven exhaust system under the influence of wind causing the flow of air through the sorbent. In some aspects, wind force driven exhaust system is a wind turbine ventilator. In some aspects, the wind force driven exhaust system includes a vertical axis wind turbine coupled to an exhaust fan.

In some aspects, the sorbent is at least one of a solid sorbent, a liquid sorbent, a gel-based sorbent, a semi-solid, a suspension-based sorbent, or a slurry-based sorbent. In some aspects, the interaction of CO₂ in the air with the sorbent includes at least one of absorption, adsorption, physisorption, chemisorption, dissolution, reactive absorption, chemical reaction, catalytic conversion, mineral carbonation, an electrochemical reaction, or combinations thereof. In some aspects, the sorbent includes at least one of an amine, an amino acid, an amino acid salt, an alkali metal hydroxide, an alkaline earth metal hydroxide, an alkali metal carbonate, a transition metal hydroxide, a metal silicate, an ionic liquid, or combinations thereof.

Embodiments described herein are directed to a stand-alone apparatus for carbon dioxide capture comprising: a sorbent for capture of CO₂ placed inside an air contactor, the air contactor having an inlet of air and an outlet of air; and a wind turbine ventilator coupled to the air contactor, the motion of the wind turbine ventilator under the influence of wind causing the flow of air through the sorbent. In some aspects, the mechanism of interaction CO₂ in the air with the sorbent includes absorption, adsorption, mineral carbonation, chemisorption, physisorption, dissolution, chemical reaction, or electrochemical reaction.

Embodiments described herein also relate to a stand-alone apparatus for carbon dioxide capture comprising: a sorbent for capture of CO₂ placed inside an air contactor, the air contactor having an inlet of air and an outlet of air; and a wind turbine coupled to a fan placed at either the inlet or the outlet of the air contactor, the motion of the wind turbine under the influence of wind causing the flow of air through the sorbent.

Embodiments described herein also relate to a stand-alone apparatus for carbon dioxide capture comprising: an air contactor having an air inlet and an air outlet; a sorbent for capture of CO₂ disposed inside the air contactor; and a wind turbine ventilator coupled to air outlet of the air contactor.

In some aspects, the motion of the wind turbine ventilator causes a pressure differential in the air contactor leading to the flow of air through the sorbent. In some aspects, the wind turbine ventilator is configured to operate interchangeably under the effect of wind, or an electric motor.

In some aspects, the sorbent is at least one of a solid sorbent, a liquid sorbent, a gel-based sorbent, a semi-solid, a suspension-based sorbent, or a slurry-based sorbent. In some aspects, the interaction of CO₂ in the air with the sorbent includes at least one of absorption, adsorption, physisorption, chemisorption, dissolution, reactive absorption, chemical reaction, catalytic conversion, mineral carbonation, electrochemical reaction, or combinations thereof. In some aspects, the sorbent includes at least one of an amine, an amino acid, an amino acid salt, an alkali metal hydroxide, an alkaline earth metal hydroxide, an alkali metal carbonate, a transition metal hydroxide, a metal silicate, or combinations thereof.

Embodiments described herein further relate to a method of CO₂ capture comprising: disposing a sorbent for CO₂ capture inside an air contactor, the air contactor including an air inlet and an air outlet; and flowing air through the air contactor, wherein the air flow through the air contactor is caused by the motion of a wind turbine mounted on the air outlet of the air contactor.

In some aspects, the wind turbine is at least one of a wind turbine ventilator, a whirlybird ventilator, or a turbine exhaust. In some aspects, the wind turbine is configured to operate interchangeably under the effect of wind, or an electric motor. In some aspects, the wind turbine includes a vertical axis wind turbine coupled to an exhaust fan.

In some aspects, the sorbent is at least one of a solid sorbent, a liquid sorbent, a gel-based sorbent, a semi-solid, a suspension-based sorbent, or a slurry-based sorbent. In some aspects, the interaction of CO₂ in the air with the sorbent includes at least one of absorption, adsorption, physisorption, chemisorption, dissolution, reactive absorption, chemical reaction, catalytic conversion, mineral carbonation, electrochemical reaction, or combinations thereof. In some aspects, the sorbent includes at least one of an amine, an amino acid, an amino acid salt, an alkali metal hydroxide, an alkaline earth metal hydroxide, an alkali metal carbonate, a transition metal hydroxide, a metal silicate, an ionic liquid, or combinations thereof.

Embodiments described herein further relate to a stand-alone apparatus for carbon dioxide capture comprising: a sorbent for capture of CO₂ placed inside an air contactor, the air contactor having an inlet and an outlet; and an array wind turbines mounted on the air contactor, the wind turbines coupled to a fan non-coaxially, the fan placed at the outlet of the air contactor, wherein the rotational motion of the wind turbines under the influence of wind causes the rotation of the fan which in turn causes the flow of air through the sorbent.

These and other objects, features, and advantages of the present disclosure will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a block diagram of a direct air capture system, according to an embodiment;

FIG. 2 is a schematic of a direct air capture system, according to an embodiment;

FIG. 3 is a schematic of an alternative direct air capture system, according to an embodiment;

FIG. 4 is a schematic of an alternative direct air capture system, according to an embodiment;

FIG. 5 is a schematic of an alternative direct air capture system, according to an embodiment; and

FIG. 6 is a schematic of an alternative direct air capture system, according to an embodiment.

Corresponding reference characters indicate corresponding parts throughout the several views. The exemplifications set out herein illustrate embodiments of the disclosure and such exemplifications are not to be construed as limiting the scope of the disclosure in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the disclosure.

In the following description, for the purposes of explanation, numerous specific details are set forth in order to provide a thorough understanding of the described embodiments. It will be apparent to one skilled in the art however that other embodiments of the present disclosure may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the disclosure, as other embodiments of the disclosure may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this disclosure is susceptible to embodiments of many different forms, it is intended that the present disclosure be considered as an example of the principles of the disclosure and not intended to limit the disclosure to the specific embodiments shown and described.

Direct Air Capture has been proposed as an effective method of carbon dioxide removal from the atmosphere. Since the concentration of CO₂ in air is quite low (˜0.04%), large quantities of air need to be flown through the sorbent using fans: around 2 million m³ of air needs to be flown per ton of CO₂ for a sorbent with high efficiency of absorption. Therefore, direct air contactors have high energy consumption which leads to high operational cost. There is a need for direct air contactors with low energy consumption. Further, there is a need to have standalone direct air contactors that can be deployed in remote areas.

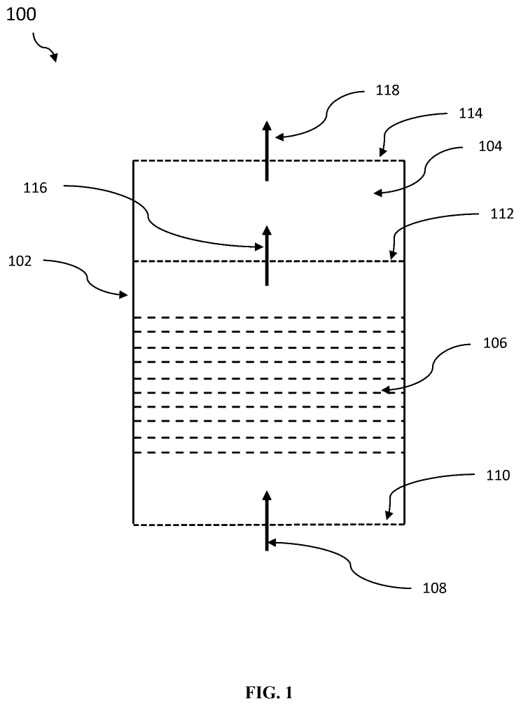

FIG. 1 shows a block diagram of a system 100 for direct air capture of CO₂. The system 100 comprises an air contactor 102, a wind force driven exhaust system 104 coupled to the air contactor 102, and a sorbent 106 disposed within the air contactor 102. The air contactor 102 has an inlet of air 110 and an outlet of air 112, the outlet of air 112 serving as inlet to the wind force driven exhaust system 104.

The bold arrows 108, 116 and 118 show the flow of air through the system 100. The wind flow driven exhaust system 104 rotates in response to the flow of wind, and in the process pulls air from within the air contactor. This leads to air being pulled into the air contactor from the inlet 110, causing a flow of air in the air contactor from the air inlet to the air outlet. The sorbent 106 placed the path of the air flow interacts with the carbon dioxide in the air, the interaction leading to removal of a portion of CO₂ from the air.

As shown in FIG. 1, the air contactor 102 comprises air inlet 110 in communication with the outer environment serving as an inlet of ambient air, and an opening 112 in communication with the exhaust system 104. In some embodiments, the direction of air flow 108 may be reversed. In that case the opening 110 as outlets for air flow 108 while opening 112 acts as an inlet of air flow from the wind force driven exhaust system.

The air contactor 102 may have any geometrical cross-section including, but not limited to, circle, square, rectangle, parallelogram, rhombus, star shape, an irregular cross-section, or a variable cross-section. The height of the air contactor may be in the range between about 10 cm and about 50 m. The lateral dimensions of the air contactor 102 may be in between 10 cm and about 100 m. The air inlet 110 may be on the one of sides of the air contactor 102 or the bottom of the air contactor 102. In some embodiments, the air inlet 110 is either a clear opening or a diffuse opening. In some embodiments, a portion of the side wall of the air contactor 102 has a porous/diffuse opening or a clear opening that allow for air flow 108.

In some embodiments, the air inlet 110 comprises an array of clear openings. In some embodiments, the total area of the clear opening(s) is between about 5 cm² and about 100 m². In some embodiments, the total area of the clear openings is in the range between about 1% to about 80% of the exterior surface area of the air contactor 102.

In some embodiments, the air inlet 110 comprises diffuse openings. The diffuse openings may be situated on the sides of the air contactor 102 or the bottom of the air contactor 102. The area of an individual diffuse opening may be between about 0.01 mm² and about 100 mm². The total area of the diffused openings may be between about 5% and about 80% of the exterior surface area of the air contactor 102. In some embodiments, there might be clear openings followed by diffuse openings in the air flow path.

As shown in FIG. 1, the opening 112 of the air contactor 102 is coupled to the wind force driven exhaust system 104, and provides a conduit of the outflow of air from the air contactor 102. The dimensions and shape of the opening 112 may be closely matched to the dimensions and shape of the input of the wind force driven exhaust system 104. In some embodiments, an additional diffuse opening (not shown) may be placed between the sorbent 106 and the opening 112. The purpose of such a diffuse opening may be to prevent particulate matter, moisture, or other matter to enter the wind force driven exhaust system 104. In some embodiments, the diffuse opening comprises an air filter.

The wind force driven exhaust system comprises an inlet 112, and an exterior surface 114. The wind force driven exhaust system is configured to generate a flow of air through the system in response to the force of the ambient wind. The wind force driven exhaust system 104 may a wind turbine ventilator. In some embodiments, the wind turbine ventilator may be configured to rotate interchangeably via the motion of blades in response to wind-force, or driven electrically by an DC or AC electric motor.

The wind force driven exhaust system 104 may be designed to have curved blades arranged in the shape of a sphere or a segment of a sphere. In some embodiments, the wind force driven exhaust system 104 may have vertical blades arranged at the circumference of a fixed circular cross-section. In some embodiments, the wind force driven exhaust system 104 comprises a vertical axis wind turbine. The wind force driven exhaust system 104 serves a dual purpose: (a) generate torque in response to the force of the wind on its blades (b) provide a suction force under a pressure gradient created by its rotational motion leading to flow of air through the air contactor 102.

The wind turbine ventilator described in this disclosure may be characterized in literature or commercial applications as “Whirlybird ventilator”, “Wind Turbine exhaust”, “Turbine ventilator” etc. Variations of the wind turbine ventilators are commonly available and are included in the description even though not specifically recited.

In some embodiments, the wind force driven exhaust system 104 may be a vertical axis wind turbine coupled mechanically with an exhaust fan either directly or via a gear assembly. In such a configuration, the exhaust fan may not include an electric motor to operate the fan. In some embodiments, the wind force driven exhaust system 104 may be a vertical axis wind turbine coupled electrically with an exhaust fan. The wind force driven exhaust system 104 may be designed to rotate clockwise or anticlockwise.

In some embodiments, an array of wind force driven exhaust systems is coupled to an air contactor. The array of wind force driven exhaust systems may be arranged in regularly spaced rows and columns. In some embodiments, the array of wind force driven exhaust systems are arranged in a staggered fashion.

One of the major operational costs of a direct air capture operation is the energy required to flow large quantities of air through the sorbent material. This approach provides a drastic reduction in the energy required for absorption of CO₂ by direct utilization of the force of the wind to flow large quantities of air through the sorbent 106 disposed inside air contactor 102.

The sorbent 106 is disposed inside the air contactor 102 such that the air flows through the sorbent 106 under the effect of pressure gradient created by the rotational motion of the wind turbine ventilator. The sorbent 106 may be disposed within the air contactor to achieve maximum surface area for interaction with the air while achieving optimal pressure drop. The sorbent 106 may be a solid sorbent, a liquid sorbent, a liquid sorbent including a suspension of solid particles, a gel-based sorbent, a slurry-based sorbent, a suspension-based sorbent, or a semi-solid-based sorbent.

In some aspects, the mechanism of interaction CO₂ in the air with the sorbent includes absorption, adsorption, physisorption, chemisorption, dissolution, reactive absorption, chemical reaction, catalytic conversion, mineral carbonation, electrochemical reaction, or combinations thereof. In some embodiments, the sorbent 106 reactively absorbs CO₂ from the air. In some embodiments, the moisture in the air enhances the rate of reactive absorption of CO₂ from the air. In some embodiments, the moisture in the air participates in the reactive absorption of CO₂ from the air.

In some embodiments, the CO₂ in the air physically adsorbs on the sorbent surface. In some embodiments, the moisture in the air enhances the rate of adsorption of CO₂ on the sorbent surface. In some embodiments, the moisture in the air reduces the rate of adsorption of CO₂ on the sorbent surface. In some embodiments, the moisture in the air reduces the capacity of adsorption of CO₂ on the sorbent surface by competing with CO₂ for the active adsorption sites on the sorbent surface. In such cases, the sorbent 106 may include additional compounds to absorb the moisture in the air.

The sorbent 106 can be a solid, gel-like, semi-solid or hygroscopic material such that there are air gaps in between the particles of the sorbent material through which the air flows. The sorbent material can be porous. In some embodiments, each particle of the sorbent material may have hierarchical porosity. The sorbent 106 can be a fixed bed of pellets, each pellet comprising porosity within. In some embodiments, a portion of porosity within the sorbent particles is an open cell porosity such that air can flow or diffuse through the pores within the sorbent particle. In some embodiments, the sorbent is a structured sorbent. In some embodiments, the sorbent is a structured monolith. In some embodiments, the sorbent is a rotating packed bed.

In some embodiments, the sorbent is a solid sorbent comprising at least one of a zeolite, a metal-organic framework (MOF), activated carbon, mesoporous silica, amine impregnated mesoporous silica, another sorbent compound impregnated in a mesoporous or microporous host material, or combinations thereof. In some embodiments, the amine impregnated in mesoporous/microporous silica (or another host material) is chemically grafted to the surface of the pores. In some embodiments, the sorbent impregnated in the mesoporous or microporous host material may be chemically reactive to CO₂ or physically adsorb the CO₂.

In some embodiments, the sorbent 106 comprises an alkali metal hydroxide such as sodium hydroxide, potassium hydroxide, or lithium hydroxide which converts to an alkali metal carbonate such as to sodium carbonate, potassium carbonate or lithium carbonate respectively after reactive absorption of CO₂ from the air. In some cases, the alkali metal carbonate so formed may further be converted to alkali metal bicarbonate by reactive absorption of CO₂ and moisture present in the air.

In some embodiments, the sorbent 106 comprises an alkaline earth metal hydroxide such as calcium hydroxide or magnesium hydroxide which gets converted an alkaline earth metal carbonate such as calcium carbonate or magnesium carbonate respectively after reactive absorption of CO₂ from the air. In some embodiments, the sorbent 106 comprises an alkaline earth metal oxide such as calcium oxide or magnesium oxide which gets converted an alkaline earth metal carbonate such as calcium carbonate or magnesium carbonate respectively after reactive absorption of CO₂ and moisture from the air.

In some embodiments, the sorbent 106 comprises an alkali metal carbonate, the alkali metal being at least one of sodium, potassium. In such a case, the alkali metal carbonate gets converted to the corresponding alkali metal bicarbonate after reactive absorption of CO₂ and moisture from the air.

In some embodiments, the sorbent 106 comprises a transition metal hydroxide, the transition metal being at least one of Copper, Zinc, Cobalt, Nickel, Iron, Chromium, Molybdenum, Vanadium, Manganese, or combinations thereof. In such a case, the transition metal hydroxide gets converted to the corresponding transition metal carbonate after reactive absorption of CO₂ from the air. In some embodiments, the sorbent 106 comprises a transition metal oxide, the transition metal being at least one of Copper, Zinc, Cobalt, Nickel, Iron, Chromium, Molybdenum, Vanadium, Manganese, or combinations thereof. In such a case, the transition metal hydroxide gets converted to the corresponding transition metal carbonate after reactive absorption of CO₂ and moisture from the air.

In some embodiments, the sorbent 106 includes a combination of an alkali metal hydroxide, an alkaline earth metal oxide or hydroxide, a transition metal oxide or hydroxide, an alkali metal carbonate, a metal silicate, an amine, an amino acid, an amino acid salt, or an ionic liquid.

In some embodiments, the sorbent 106 includes an industrial alkaline waste such as steel slag, blast furnace slag, coal fly ash, coal bottom ash, cement kiln dust, municipal incinerator solid waste fly ash, municipal incinerator bottom ash, red mud etc.

In some embodiments, the sorbent 106 comprises a metal silicate. The metal silicate may include at least one of calcium silicate, magnesium silicate, magnesium iron silicate, an aluminosilicate, or combinations thereof. In some embodiments, the metal silicate comprises water of hydration bound to the metal silicate. The metal silicate may be derived from industrial alkaline waste such as steel slag, blast furnace slag, coal fly ash, coal bottom ash, cement kiln dust, municipal incinerator solid waste fly ash, municipal incinerator bottom ash, red mud etc. The metal silicate may be a natural silicate mineral such as mafic rock, ultramafic rock, basalt, peridotite, serpentine, olivine, wollastonite, plagioclase (anorthite), ophiolite etc.

When the sorbent 106 is a metal silicate, the reactive absorption of CO₂ is enhanced by the presence of moisture in the air. The moisture condenses on the surface of the sorbent material including the pores, the CO₂ from air dissolves in it forming carbonic acid lowering the pH of the condensed moisture. The metal silicate reacts with the carbonic acid forming metal carbonate and silica.

In some embodiments, the sorbent 106 is a bed of metal silicate pellets, wherein the pellets are formed by mixing metal silicate powder with other additives. The additives include a binder material, a hygroscopic compound, a promoter to enhance the reactive absorption of CO₂, a solvent, or combinations thereof.

In some embodiments, CO₂ in the air dissolves in the solvent that is added as an additive to the sorbent 106. In some embodiments, the solvent facilitates the transport of at least one of dissolved CO₂, carbonate ions, hydroxide ions, protons, hydronium ions, metal ions, or combinations thereof. In some embodiments, solvent is miscible with water. In some embodiments, the solvent is a non-volatile solvent that has low vapor pressure under the operational conditions. In some embodiments, the solvent has CO₂ absorbing properties via physical dissolution, physisorption, chemisorption, or reactive absorption.

In some embodiments, the solvent is hygroscopic. In some embodiments, the solvent or mixture of solvent with water has a freezing point below the temperature of operation of the system. In some embodiments, the solvent or mixture of solvent with water has a freezing point in the range between about 0° C. and about-40° C. In some embodiments, the solvent includes at least one of glycerol, ethylene glycol, propylene glycol, propylene carbonate, an ether compound, a eutectic mixture of urea with choline chloride, or mixtures thereof. In some embodiments, the solvent is a liquid amine compound with low vapor pressure, such as triethanolamine. In some embodiments, the solvent is in the range between about 1% and about 50% by weight of the sorbent 106.

In some embodiments, the sorbent 106 may be formed as pellets. In some embodiments, the pellets/particles of sorbent 106 may absorb moisture from the air, either due to condensation of moisture on the surface or pores, or due to the presence of a hygroscopic compound or other materials in the pellets. In such a case, the adsorbed/absorbed moisture along with any other solvents/liquids/gels present in the pellets act as a medium for the reaction between the CO₂ in the air and the metal silicate in the pellet. In such a case, the rate of reaction of CO₂ from air into the metal silicate is dependent on the rate of dissolution of CO₂ in the pellet, rate of diffusion of solvated CO₂ to the reaction interface and rate of reaction of solvated CO₂ with the metal silicate to form insoluble metal carbonate and silica.

The rate of dissolution of CO₂ is dependent on the pH at the air/solid interface, air/moisture interface, or the air/liquid medium interface. Higher pH increases the rate of reactive dissolution of CO₂ to form either carbonate ions, bicarbonate ions, or both. Presence of promoter or catalytic materials may further enhance the rate of reaction absorption or reactive dissolution of CO₂. The adsorbed moisture and/or the presence of solvent in the pellets facilitates the transport of solvated CO₂ in the form of carbonate ions or bicarbonate ions to the reaction interface. Higher diffusion rate of these ions enhances the rate of the overall reaction. The rate of the reaction of carbonate ions or bicarbonate ions with the metal silicate is a function of the metal silicate particle size, availability of these ions, operating temperature, and rate of dissolution and transport of hydroxide ions in the medium.

In some embodiments, the metal silicate powder (used to make the pellets) has a particle size in the range between about 50 nm and about 1 mm. In some embodiments, the metal silicate powder may have a particle size in the range between about 50 nm and about 500 nm. In some embodiments, the metal silicate powder may have a particle size in the range between about 500 nm and about 1 micron. In some embodiments, the metal silicate powder may have a particle size in the range between about 1 micron and about 10 microns. The metal silicate powder may have a particle size in the range between about 10 micron and about 50 microns. In some embodiments, the metal silicate powder may have a particle size in the range between about 50 micron and about 100 microns. In some embodiments, the metal silicate powder may have a particle size in the range between about 100 microns and about 500 microns. In some embodiments, the metal silicate powder may have a particle size in the range between about 500 microns and about 1 mm. In some embodiments, the particle sizes are a bimodal distribution such that the particle sizes may fall in any two of size ranges described above. In some embodiments, the particle sizes are a multimodal distribution such that the particle sizes may fall in more than two of the size ranges described above.

In some embodiments, the pellets or particles of sorbent 106 are porous. The porosity helps the CO₂ from the air diffuse inside the pellets to be able to react/adsorb with the sorbent material. In some embodiments, the porosity may be in the range between about 50 nm and about 1 mm. The porosity may be in the range between about 50 nm and about 500 nm. In some embodiments, the porosity may be in the range between about 500 nm and about 1 micron. In some embodiments, the porosity may be in the range between about 1 micron and about 10 microns. In some embodiments, the porosity may be in the range between about 10 microns and about 50 microns. In some embodiments, the porosity may be in the range between about 50 microns and about 100 microns. In some embodiments, the porosity may be in the range between about 100 microns and 500 microns.

In some embodiments, the pellets or particles of sorbent 106 have hierarchical porosity such that the air flow 108 through the air contactor leads to diffusion of air through the pores. In some embodiments, the porosity in the metal silicate pellets may be completely or partially filled due to moisture absorption by the hygroscopic components of the pellets.

In some embodiments, the pellets of sorbent 106 are disposed in the air contactor 102 such that there is high degree of gaps in between the pellets. The filling of pellets in the air contactor is defined by a packing fraction defined as the solid volume divided by the total volume occupied by the pellets which includes the solid volume and the volume of the air between the pellets. In some embodiments, the packing fraction is between about 30% and about 90%. In some embodiments, the packing fraction is between about 40% and 80%. In some embodiments the packing fraction is between 50% and 70%. In some embodiments, the packing fraction is at least 25%. In some embodiments, the packing fraction is at most 95%.

The packing fraction of the pellets are decided by the size of the pellets, size distribution of the pellets and the shape of the pellets. The shape of the pellets may be round, oval, cylindrical, cubical, cuboidal, star shaped, irregular or any other shape. The shape of the pellet determines the air pressure drop between the inlet of air and outlet of the air which may determine the volume flux of the air flow 108 for a given wind force driven exhaust system 104. A high packing fraction may lead to large pressure drop and hence a small air flow volume but it allows for higher dwell time for the CO₂ in the air to react with the sorbent 106. On the other hand, the smaller packing fraction would lead to lower pressure drop and higher air flow 108 but a smaller dwell time for the CO₂ in the air to react with the sorbent 106.

The particle shape, size and size distribution and packing fraction may be chosen to maximize the mathematical product of air flow and the dwell time of the air through the sorbent 106. In some embodiments, the optimal packing fraction may be between about 40% and about 60%. In some embodiments, the optimal packing fraction may be between about 45% and about 55%.

In some embodiments, the pellets may have a mixture of a first reactive compound and a second reactive compound such that one of them has a faster rate of reaction with CO₂ (or CO₂ and H₂O) in the air compared to the other. In such a case, multiple reactions may occur in parallel or in series due to the air flow through the system. In such case, the reaction product formed in-situ may further react with CO₂ in the air, or other compound(s) in the pellets which may have been originally present or formed in-situ.

In some embodiments, the first reaction product, formed in-situ by the reaction of first reactive compound in the pellet with CO₂ in the air, further reacts with the second reactive compound in the pellet to form a second reaction product. In some embodiments, the second reaction product formed in-situ may further react with the CO₂ in the air to form a third reaction product. In some embodiments, the third reaction product produced in situ may be the same as the first reactive compound originally present in the pellet.

An example of such a system may be sodium hydroxide as first reactive compound and metal silicate as the second reactive compound. Sodium hydroxide reacts with CO₂ in the air to form sodium carbonate in-situ as the first reaction product. The sodium carbonate formed in-situ further reacts with metal silicate to form insoluble metal carbonate, silica, and sodium hydroxide is generated in-situ as the second reaction product being the same as first reactive compound.

The sodium hydroxide formed in-situ further reacts with CO₂ in the air to form sodium carbonate in-situ. The reaction cycle continues until there is no more metal silicate available for the reaction with the sodium carbonate. In some embodiments, the sodium hydroxide acts as an agent to activate the metal silicate for reaction with sodium carbonate by taking up any water of hydration which is bound to the metal silicate. In some embodiments, the sodium hydroxide as the first reactive compound acts as a catalyst.

In some embodiments, relative percentage by weight of the first reactive compound with the respect to the second reactive compound may be between 0.1% and about 70%. In some embodiments, relative percentage by weight of the first reactive compound with respect to the second reactive compound may be between 0.1% and about 1%. In some embodiments, relative percentage by weight of the first reactive compound with the respect to the second reactive compound may be between 1% and about 10%. In some embodiments, relative percentage by weight of the first reactive compound with respect to the second reactive compound may be between 10% and about 20%. In some embodiments, relative percentage by weight of the first reactive compound with respect to the second reactive compound may be between 20% and about 40%. In some embodiments, relative percentage by weight of the first reactive compound with the respect to the second reactive compound may be between 40% and about 60%.

In some embodiments, the first reactive compound is sodium hydroxide and second reactive compound is metal silicate. In some embodiments, potassium hydroxide, lithium hydroxide or another alkali metal hydroxide may be used in place of sodium hydroxide. In some embodiments, the first reactive compound acts as a catalyst for the carbonation of second reactive compound. In some embodiments, the first reactive compound is an alkali metal hydroxide, and the second reactive compound is an alkaline earth metal hydroxide.

Another example of such a system may be sodium carbonate as first reactive compound and metal silicate as the second reactive compound mixed together with small amount of water to form a paste which is cast into pellets. In some embodiments, the metal silicate and sodium carbonate are mixed together as solids to form pellets. While sodium carbonate is hygroscopic, there may be other hygroscopic ingredients in the mixture which lead to absorption of moisture in the pellet. The moisture dissolves a portion of the sodium carbonate, and facilitates the reaction between sodium carbonate and metal silicate to form insoluble metal carbonate, silica, and sodium hydroxide is generated in-situ as the first reaction product.

The sodium hydroxide formed in-situ is also hygroscopic and further reacts with CO₂ in the air to form sodium carbonate in-situ as the second reaction product. The sodium carbonate formed in-situ and metal silicate react further to form insoluble metal carbonate, silica, and sodium hydroxide is generated in-situ as the third reaction product which is available to react with CO₂ in air to form sodium carbonate. The reaction cycle continues until there is no more metal silicate available for the reaction with the sodium carbonate. In some embodiments, the sodium hydroxide acts as an agent to activate the metal silicate for reaction with sodium carbonate by taking up any water of hydration which is bound to the metal silicate. In some embodiments, the sodium hydroxide as the first reactive compound acts as a catalyst.

In some embodiments, the first reactive compound may be chosen for a list comprising an amine compound, an amino acid, a borate compound, a vanadate compound, an arsenate compound, an ionic liquid, a fully carbonated amine compound comprising carbamate ions, a metal carbamate, or another compound that reactively absorbs CO₂. In some embodiments, the first reaction product, formed by reaction of first reactive compound with CO₂ in air, hydrolyzes in the presence of moisture to form bicarbonate ions and/or carbonate ions and corresponding cation. The bicarbonate ions further react with second reactive compound such as metal silicate to form hydroxide ions along with corresponding cations. In some embodiments, the hydroxide ions formed in-situ reactively absorb CO₂ from the air to form carbonate ions and/or bicarbonate ions. The reaction cycle continues until all the metal silicate available for the reaction is consumed.

In some embodiments, there may be three reactive compounds that may be present as a mixture in sorbent 106 formed as pellets. In one exemplary case, the three reactive compounds are sodium hydroxide, sodium carbonate and metal silicate. In some embodiments, the sodium hydroxide as the first reactive compound acts as a catalyst. In some embodiments, the weight percentage of either the first reactive compound, second reactive compound or third reactive compound relative to the total weight of first, second and third reactive compounds is between 0.01% and about 70%. In some embodiments, the first reactive compound acts as a catalyst.

In another exemplary case, the three reactive compounds are such that the first reactive compound may be chosen from a list comprising an amine compound, an amino acid, an amino acid salt, a borate compound, a vanadate compound, an arsenate compound, an ionic liquid, a fully carbonated amine compound comprising carbamate ions, a metal carbamate, or another compound that reactively absorbs CO₂; the second reactive compound is sodium hydroxide; and the third reactive compound is metal silicate. In some embodiments, the first reactive product, formed by reaction of first reactive compound with CO₂ in air, hydrolyzes in the presence of moisture to form bicarbonate ions and/or carbonate ions and corresponding cation.

The bicarbonate ions further react with second reactive compound such as sodium hydroxide to form carbonate ions. The carbonate ions formed in-situ further react with third reactive compound such as metal silicate to form hydroxide ions along with corresponding cations. In some embodiments, the hydroxide ions reactively absorb CO₂ from the air to form carbonate ions and/or bicarbonate ions. The reaction continues until all the metal silicate available for the reaction is consumed. In some embodiments, at least one of the first reactive compound or the second reactive compound acts as a catalyst.

The chemical compositions of sorbent 106 described in the solid form above also hold true for other forms of sorbent such as a gel-based sorbent, a semi-solid based sorbent, a slurry-based sorbent, a liquid sorbent, or a liquid sorbent including a suspension of solid particles.

In some embodiments, the sorbent 106 is a liquid sorbent. The liquid sorbent may include an aqueous solution of an alkali metal hydroxide, an aqueous solution of an alkali metal carbonate, or a slurry or suspension of an alkaline earth metal hydroxide. The liquid sorbent may also include an aqueous solution of an amine, an amino acid, an amino acid salt. When liquid-based sorbents are used, the system further comprises a means for circulating the liquid-based sorbent in the air contactor 102 for optimal contact between the liquid-based sorbent and air.

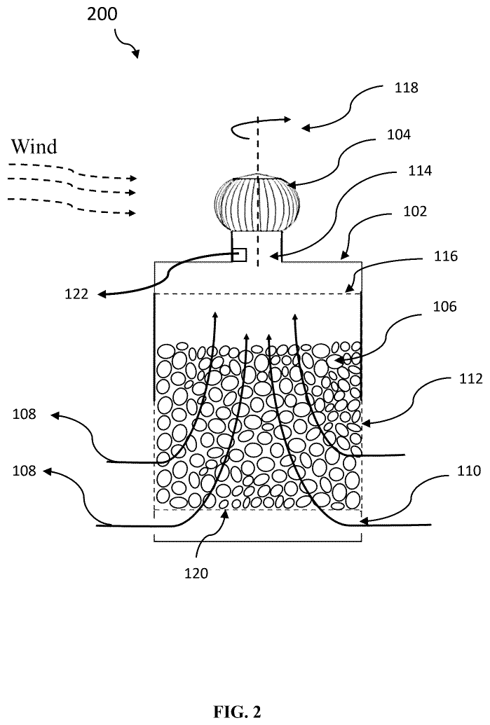

FIG. 2 shows a standalone system 200 for direct air capture of CO₂. The device comprises an air contactor 202, a wind turbine ventilator 204 coupled to the air contactor 202, and a sorbent 206 placed inside the air contactor 202. The air contactor 202 has an inlet of air and an outlet of air. The wind turbine ventilator rotates (218) in response to the flow of wind, and in the process pulls air from within the air contactor. This leads to air being pulled into the air contactor from the inlet causing a flow of air in the air contactor from the air inlet to the air outlet. The sorbent 206 placed the path of the air flow (208) interacts with the carbon dioxide in the air, the interaction leading to removal of a portion of CO₂ from the air as it exits the air contactor 202.

As shown in FIG. 2, the air contactor 202 comprises openings 210, 212 and 214 which are in communication with the outer environment. In this particular example shown in FIG. 2, the openings 210 and 210 act as inlet for air flow 208, and opening 214 acts as an outlet for air flow from the air contactor 202. In some embodiments, the direction of air flow 208 may be reversed. In that case the openings 210 and 212 act as outlets for air flow 208 while opening 214 acts as an inlet.

The air contactor 202 may have any geometrical cross-section including, but not limited to, circle, square, rectangle, parallelogram, rhombus, star shape, an irregular cross-section, or a variable cross-section. The height of the air contactor may be in the range between about 10 cm and about 50 m. The lateral dimensions of the air contactor 202 may be in between 10 cm and about 100 m. The opening 210 may be on the one of sides of the air contactor 202 or the bottom of the air contactor 202. In some embodiments, the opening 202 is either a clear opening or a diffuse opening. In some embodiments, a portion of the side wall of the air contactor 202 has a porous/diffuse opening or a clear opening that allow for air flow 208.

In some embodiments, the air contactor 202 has an array of clear openings 210. In some embodiments, the total area of the clear opening(s) 210 is between about 5 cm² and about 10 m². In some embodiments, the total area of the clear openings is in the range between about 1% to about 80% of the exterior surface area of the air contactor 202.

In some embodiments the diffuse openings may be situated on the sides of the air contactor 202 or the bottom of the air contactor 202. The area of an individual diffuse opening may be between about 0.01 mm² and about 100 mm². The total area of the diffused openings may be between about 5% and about 80% of the exterior surface area of the air contactor 202. In some embodiments, there might be clear openings followed by diffuse openings in the air flow path as shown in FIG. 2 (210 is the clear opening followed by diffused opening 220).

As shown in FIG. 2, the opening 214 of the air contactor 202 is coupled to the wind turbine ventilator 204, and in this particular case provides a conduit of the outflow of air from the air contactor 202. The dimensions and shape of the opening 214 may be closely matched to the dimensions and shape of the input of the wind turbine ventilator 204. In some embodiments, an additional diffuse opening 216 may be placed between the sorbent 206 and the opening 214. The purpose of the diffuse opening 216 may be to stop any particulate matter, moisture, or other matter to enter the wind turbine ventilator 204.

The wind turbine ventilator 204 may be designed to rotate clockwise or anticlockwise. In the specific case shown in FIG. 2, the axis of rotation 218 is clockwise. The wind turbine ventilator may be designed to have curved blades arranged in the shape of a sphere (as shown in FIG. 2). In some embodiments, the wind turbine ventilator may have vertical blades arranged at the circumference of a fixed circular cross-section. The wind turbine ventilator serves a dual purpose: (a) generate torque in response to the force of the wind on its blades (b) provide a suction force under a pressure gradient created by its rotational motion leading to flow of air through the air contactor 202.

One of the major operational costs of a direct air capture operation is the energy required to flow large quantities of air through the sorbent material. This approach provides a drastic reduction in the energy required for absorption of CO₂ by direct utilization of the forces of the wind to flow large quantities of air through the air contactor 202. For example, a wind turbine ventilator having a 12-inch diameter provides an air flow of 3500 cubic feet per minute (cfm) through the air contactor 202 when the ambient wind is blowing at a speed of 4 miles per hour (mph). This level of wind speed is common in most regions of North America and this air flow would correspond to more than 25 tons of CO₂ flowing through the system in one year.

In coastal areas, the average wind speeds are in the range of 15 mph while mid-west regions have an average wind speed of 10 mph. The corresponding air flow rate for a 12-in diameter wind turbine ventilator system placed in these areas are in the range of 22000 cfm and 7000 cfm respectively. Therefore, the wind turbine ventilator 204 coupled to the air contactor 202 having sorbent 206 can provide significant air flow, and hence large savings in energy and operational cost. Such a system can be operated without any connection to a power source or to the electrical grid and therefore offers huge flexibility in siting a direct air project utilizing this system.

The wind turbine ventilator 204 described in this disclosure may be characterized in literature or commercial applications as “Whirlybird ventilator”, “Wind Turbine exhaust”, “Turbine ventilator” etc. Variations of the wind turbine ventilators are commonly available and are included in the description even though not specifically recited.

As shown in FIG. 2, the sorbent 206 is placed inside the air contactor 202 such that the air flows through the sorbent 206 under the effect of pressure gradient created by the rotational motion of the wind turbine ventilator. In some aspects, the mechanism of interaction CO₂ in the air with the sorbent includes absorption, adsorption, mineral carbonation, chemisorption, physisorption, dissolution, chemical reaction, or electrochemical reaction. In some embodiments, the sorbent 206 reactively absorbs CO₂ from the air. In some embodiments, the moisture in the air enhances the rate of reactive absorption of CO₂ from the air. In some embodiments, the moisture in the air participates in the reactive absorption of CO₂ from the air.

In some embodiments, the CO₂ in the air physically adsorbs on the sorbent surface. In some embodiments, the moisture in the air enhances the rate of adsorption of CO₂ on the sorbent surface. In some embodiments, the moisture in the air reduces the rate of adsorption of CO₂ on the sorbent surface. In some embodiments, the moisture in the air reduces the capacity of adsorption of CO₂ on the sorbent surface by competing with CO₂ for the active adsorption sites on the sorbent surface.

The sorbent 206 can be a solid, gel-like, semi-solid or hygroscopic material such that there are air gaps in between the particles of the sorbent material through which the air flows. The sorbent material can be porous. In some embodiments, each particle of the sorbent material may have hierarchical porosity. The sorbent 206 can be a fixed bed of pellets, each pellet comprising porosity within. In some embodiments, a portion of porosity within the sorbent particles is an open cell porosity such that air can flow or diffuse through the pores within the sorbent particle. In some embodiments, the sorbent is a structured sorbent. In some embodiments, the sorbent is a structured monolith. In some embodiments, the sorbent is a rotating packed bed.

In some embodiments, the sorbent is a solid sorbent comprising at least one of zeolites, metal-organic frameworks (MOFs), activated carbon, mesoporous silica, amine impregnated mesoporous silica, another sorbent compound impregnated in a mesoporous or microporous host material, or combinations thereof. In some embodiments, the amine impregnated in mesoporous/microporous silica (or another host material) is chemically grafted to the surface of the pores. In some embodiments, the sorbent impregnated in the mesoporous or microporous host material may be chemically reactive to CO₂ or physically adsorb the CO₂.

In some embodiments, the sorbent 206 comprises an alkali such as sodium hydroxide, potassium hydroxide, or lithium hydroxide which respectively convert to sodium carbonate, potassium carbonate or lithium carbonate after reactive absorption of CO₂ from the air. In some embodiments, the sorbent 206 comprises calcium hydroxide or magnesium hydroxide which respectively get converted to calcium carbonate or magnesium carbonate after reactive absorption of CO₂ from the air.

In some embodiments, the sorbent 206 comprises an alkali metal carbonate, the alkali metal being at least one of sodium, potassium. In such a case, the alkali metal carbonate gets converted to the corresponding alkali metal bicarbonate after reactive absorption of CO₂ from the air.

In some embodiments, the sorbent 206 comprises a metal silicate. The metal silicate may include at least one of calcium silicate, magnesium silicate, magnesium iron silicate, aluminosilicate or combinations thereof. In some embodiments, the metal silicate comprises water of hydration bound to the metal silicate. The metal silicate may be an industrial alkaline waste such as steel slag, coal fly ash, cement kiln dust etc. The metal silicate may be a natural silicate mineral such as mafic rock, ultramafic rock, basalt, peridotite, serpentine, olivine, wollastonite, plagioclase (anorthite), ophiolite etc.

When the sorbent 206 is a metal silicate, the reactive absorption of CO₂ is enhanced by the presence of moisture in the air flowing through the sorbent 206 in the air contactor 202. The moisture condenses on the surface of the sorbent material including the pores, the CO₂ from air dissolves in it forming carbonic acid lowering the pH of the condensed moisture. The metal silicate reacts with the carbonic acid forming calcium carbonate and silica.

In some embodiments, the sorbent 206 is a bed of metal silicate pellets, wherein the pellets are formed by mixing metal silicate powder with other additives. The additives include a binder material, a hygroscopic compound, a promoter to enhance the reactive absorption of CO₂, a solvent, or combinations thereof.

In some embodiments, CO₂ in the air dissolves in the solvent that is added as an additive to the sorbent 206. In some embodiments, the solvent facilitates the transport of at least one of dissolved CO₂, carbonate ions, hydroxide ions, protons, hydronium ions, metal ions, or combinations thereof. In some embodiments, solvent is miscible with water. In some embodiments, the solvent is a non-volatile solvent that has low vapor pressure under the operational conditions.

In some embodiments, the solvent is hygroscopic. In some embodiments, the solvent or mixture of solvent with water has a freezing point below the temperature of operation of the system. In some embodiments, the solvent or mixture of solvent with water has a freezing point in the range between about 0° C. and about-40° C. In some embodiments, the solvent includes at least one of glycerol, ethylene glycol, propylene glycol, propylene carbonate, a eutectic mixture of urea with choline chloride, or mixtures thereof. In some embodiments, the solvent is in the range between about 1% and about 50% by weight of the sorbent 206.

In some embodiments, the pellet may absorb moisture from the air, either due to condensation of moisture on the surface or pores, or due to the presence of a hygroscopic compound or other materials in the pellets. In such a case, the adsorbed/absorbed moisture along with any other solvents/liquids/gels present in the pellets act as a medium for the reaction between the CO₂ in the air and the metal silicate in the pellet. In such a case, the rate of reaction of CO₂ from air into the metal silicate is dependent on the rate of dissolution of CO₂ in the pellet, rate of diffusion of solvated CO₂ to the reaction interface and rate of reaction of solvated CO₂ with the metal silicate to form insoluble metal carbonate and silica.

The rate of dissolution of CO₂ is dependent on the pH at the air/solid interface, air/moisture interface, or the air/liquid medium interface. Higher pH increases the rate of reactive dissolution of CO₂ to form either carbonate ions, bicarbonate ions, or both. Presence of promoter or catalytic materials may further enhance the rate of reaction absorption or reactive dissolution of CO₂. The adsorbed moisture and/or the presence of solvent in the pellets facilitates the transport of solvated CO₂ in the form of carbonate ions or bicarbonate ions to the reaction interface. Higher diffusion rate of these ions enhances the rate of the overall reaction. The rate of the reaction of carbonate ions or bicarbonate ions with the metal silicate is a function of the metal silicate particle size, availability of these ions, operating temperature, and rate of dissolution and transport of hydroxide ions in the medium.

In some embodiments, the metal silicate powder (used to make the pellets) has a particle size in the range between about 50 nm and about 1 mm. In some embodiments, the metal silicate powder may have a particle size in the range between about 50 nm and about 500 nm. In some embodiments, the metal silicate powder may have a particle size in the range between about 500 nm and about 1 micron. In some embodiments, the metal silicate powder may have a particle size in the range between about 1 micron and about 10 microns. The metal silicate powder may have a particle size in the range between about 10 micron and about 50 microns. In some embodiments, the metal silicate powder may have a particle size in the range between about 50 micron and about 100 microns. In some embodiments, the metal silicate powder may have a particle size in the range between about 100 microns and about 500 microns. In some embodiments, the metal silicate powder may have a particle size in the range between about 500 microns and about 1 mm. In some embodiments, the particle sizes are a bimodal distribution such that the particle sizes may fall in any two of size ranges described above. In some embodiments, the particle sizes are a multimodal distribution such that the particle sizes may fall in more than two of the size ranges described above.

In some embodiments, the metal silicate pellets are porous. The porosity helps the CO₂ from the air diffuse inside the pellets to be able to react with the metal silicate material. In some embodiments, the porosity may be in the range between about 50 nm and about 1 mm. The porosity may be in the range between about 50 nm and about 500 nm. In some embodiments, the porosity may be in the range between about 500 nm and about 1 micron. In some embodiments, the porosity may be in the range between about 1 micron and about 10 microns. In some embodiments, the porosity may be in the range between about 10 microns and about 50 microns. In some embodiments, the porosity may be in the range between about 50 microns and about 100 microns. In some embodiments, the porosity may be in the range between about 100 microns and 500 microns.

In some embodiments, the pellets have hierarchical porosity such that the air flow 208 through the air contactor leads to diffusion of air through the pores. In some embodiments, the porosity in the metal silicate pellets may be completely or partially filled due to moisture absorption by the hygroscopic components of the pellets.

In some embodiments, the pellets are filled in the air contactor such that there is high degree of gaps in between the pellets. The filling of pellets in the air contactor is defined by a packing fraction defined as the solid volume divided by the total volume occupied by the pellets which includes the solid volume and the volume of the air between the pellets. In some embodiments, the packing fraction is between about 30% and about 90%. In some embodiments, the packing fraction is between about 40% and 80%. In some embodiments the packing fraction is between 50% and 70%. In some embodiments, the packing fraction is at least 25%. In some embodiments, the packing fraction is at most 95%.

The packing fraction of the pellets are decided by the size of the pellets, size distribution of the pellets and the shape of the pellets. The shape of the pellets may be round, oval, cylindrical, cubical, cuboidal, star shaped, irregular or any other shape. The shape of the pellet determines the air pressure drop between the inlet of air and outlet of the air which may determine the volume flux of the air flow 208 for a given wind turbine ventilator 204. A high packing fraction may lead to large pressure drop and hence a small air flow volume but it allows for higher dwell time for the CO₂ in the air to react with the sorbent 206. On the other hand, the smaller packing fraction would lead to lower pressure drop and higher air flow 208 but a smaller dwell time for the CO₂ in the air to react with the sorbent 206.

The particle shape, size and size distribution and packing fraction may be chosen to maximize the mathematical product of air flow 208 and the dwell time of the air through the sorbent 206. In some embodiments, the optimal packing fraction may be between about 40% and about 60%. In some embodiments, the optimal packing fraction may be between about 45% and about 55%.

In some embodiments, the pellets may have a mixture of a first reactive compound and a second reactive compound such that one of them has a faster rate of reaction with CO₂ (or CO₂ and H₂O) in the air compared to the other. In such a case, multiple reactions may occur in parallel or in series due to the air flow 208 though the system. In such case, the reaction product formed in-situ may further react with CO₂ in the air, or other compound(s) in the pellets which may have been originally present or formed in-situ.

In some embodiments, the first reaction product, formed in-situ by the reaction of first reactive compound in the pellet with CO₂ in the air, further reacts with the second reactive compound in the pellet to form a second reaction product. In some embodiments, the second reaction product formed in-situ may further react with the CO₂ in the air to form a third reaction product. In some embodiments, the third reaction product produced in situ may be the same as the first reactive compound originally present in the pellet.

An example of such a system may be sodium hydroxide as first reactive compound and metal silicate as the second reactive compound. Sodium hydroxide reacts with CO₂ in the air to form sodium carbonate in-situ as the first reaction product. The sodium carbonate formed in-situ further reacts with metal silicate to form insoluble metal carbonate, silica, and sodium hydroxide is generated in-situ as the second reaction product being the same as first reactive compound.

The sodium hydroxide formed in-situ further reacts with CO₂ in the air to form sodium carbonate in-situ. The reaction cycle continues until there is no more metal silicate available for the reaction with the sodium carbonate. In some embodiments, the sodium hydroxide acts as an agent to activate the metal silicate for reaction with sodium carbonate by taking up any water of hydration which is bound to the metal silicate. In some embodiments, the sodium hydroxide as the first reactive compound acts as a catalyst.

In some embodiments, relative percentage by weight of the first reactive compound with the respect to the second reactive compound may be between 0.1% and about 70%. In some embodiments, relative percentage by weight of the first reactive compound with respect to the second reactive compound may be between 0.1% and about 1%. In some embodiments, relative percentage by weight of the first reactive compound with the respect to the second reactive compound may be between 1% and about 10%. In some embodiments, relative percentage by weight of the first reactive compound with respect to the second reactive compound may be between 10% and about 20%. In some embodiments, relative percentage by weight of the first reactive compound with respect to the second reactive compound may be between 20% and about 40%. In some embodiments, relative percentage by weight of the first reactive compound with the respect to the second reactive compound may be between 40% and about 60%.

In some embodiments, the first reactive compound is sodium hydroxide and second reactive compound is metal silicate. In some embodiments, potassium hydroxide, lithium hydroxide or another alkali metal hydroxide may be used in place of sodium hydroxide. In some embodiments, the first reactive compound acts as a catalyst for the carbonation of second reactive compound.

Another example of such a system may be sodium carbonate as first reactive compound and metal silicate as the second reactive compound mixed together with small amount of water to form a paste which is cast into pellets. In some embodiments, the metal silicate and sodium carbonate are mixed together as solids to form pellets. While sodium carbonate is hygroscopic, there may be other hygroscopic ingredients in the mixture which lead to absorption of moisture in the pellet. The moisture dissolves a portion of the sodium carbonate, and facilitates the reaction between sodium carbonate and metal silicate to form insoluble metal carbonate, silica, and sodium hydroxide is generated in-situ as the first reaction product.

The sodium hydroxide formed in-situ is also hygroscopic and further reacts with CO₂ in the air to form sodium carbonate in-situ as the second reaction product. The sodium carbonate formed in-situ and metal silicate react further to form insoluble metal carbonate, silica, and sodium hydroxide is generated in-situ as the third reaction product which is available to react with CO₂ in air to form sodium carbonate. The reaction cycle continues until there is no more metal silicate available for the reaction with the sodium carbonate. In some embodiments, the sodium hydroxide acts as an agent to activate the metal silicate for reaction with sodium carbonate by taking up any water of hydration which is bound to the metal silicate. In some embodiments, the sodium hydroxide as the first reactive compound acts as a catalyst.

In some embodiments, the first reactive compound may be chosen for a list comprising an amine compound, an amino acid, a borate compound, a vanadate compound, an arsenate compound, an ionic liquid, a fully carbonated amine compound comprising carbamate ions, a metal carbamate, or another compound that reactively absorbs CO₂. In some embodiments, the first reaction product, formed by reaction of first reactive compound with CO₂ in air, hydrolyzes in the presence of moisture to form bicarbonate ions and/or carbonate ions and corresponding cation. The bicarbonate ions further react with second reactive compound such as metal silicate to form hydroxide ions along with corresponding cations. In some embodiments, the hydroxide ions formed in-situ reactively absorb CO₂ from the air to form carbonate ions and/or bicarbonate ions. The reaction cycle continues until all the metal silicate available for the reaction is consumed.

In some embodiments, there may be three reactive compounds that may be present as a mixture in sorbent 206 formed as pellets. In one exemplary case, the three reactive compounds are sodium hydroxide, sodium carbonate and metal silicate. In some embodiments, the sodium hydroxide as the first reactive compound acts as a catalyst. In some embodiments, the weight percentage of either the first reactive compound, second reactive compound or third reactive compound relative to the total weight of first, second and third reactive compounds is between 0.01% and about 70%. In some embodiments, the first reactive compound acts as a catalyst.

In another exemplary case, the three reactive compounds are such that the first reactive compound may be chosen from a list comprising an amine compound, an amino acid, an amino acid salt, a borate compound, a vanadate compound, an arsenate compound, an ionic liquid, a fully carbonated amine compound comprising carbamate ions, a metal carbamate, or another compound that reactively absorbs CO₂; the second reactive compound is sodium hydroxide; and the third reactive compound is metal silicate. In some embodiments, the first reactive product, formed by reaction of first reactive compound with CO₂ in air, hydrolyzes in the presence of moisture to form bicarbonate ions and/or carbonate ions and corresponding cation.

The bicarbonate ions further react with second reactive compound such as sodium hydroxide to form carbonate ions. The carbonate ions formed in-situ further react with third reactive compound such as metal silicate to form hydroxide ions along with corresponding cations. In some embodiments, the hydroxide ions reactively absorb CO₂ from the air to form carbonate ions and/or bicarbonate ions. The reaction continues until all the metal silicate available for the reaction is consumed. In some embodiments, at least one of the first reactive compound or the second reactive compound acts as a catalyst.

In some embodiments, the air contactor 202 includes a sensor assembly placed in the air flow path 208. In some embodiments, a sensor assembly is placed at the air inlet 210 before the interaction of air with the sorbent 206 and the sensor assembly measures the concentration of CO₂ in the input air. In some embodiments, a sensor assembly 222 is placed at or near the air outlet 214 after the interaction of air with the sorbent 206 as shown in FIG. 2, the sensor assembly measuring the concentration of CO₂ in the air at the outlet.

It is expected that the concentration of CO₂ in the air after flowing through the sorbent 206 is lower than the concentration of CO₂ at the air inlet 210. As a result, the sensor assembly 222 would show CO₂ concentration lower than that of the ambient air. Initially when the sorbent 206 is just filled in the air contactor 202, a larger portion of CO₂ is captured from the air and progressively the value of CO₂ captured per unit time decreases as more of the sorbent gets loaded with CO₂. Therefore, the sensor assembly 222 records a lower ppm value of CO₂ initially and the value keeps rising progressively over time. When the sorbent is saturated, the sensor assembly 222 placed at the outlet records a CO₂ concentration comparable to the CO₂ concentration at the inlet, thus providing a decision input for replacing the sorbent in the air contactor.

In some embodiments, the sensor assembly 222 is externally powered. In some embodiments, the sensor assembly measures the CO₂ concentration in the air constantly. In some embodiments, the sensor assembly measures the CO₂ concentration in the air intermittently. When the measurements are done intermittently, the time intervals between two measurements may be in the range between about 1 seconds and about 24 hrs. In some embodiments, the time intervals between two measurements may be in the range between about 1 seconds and about 60 seconds. In some embodiments, the time intervals between two measurements may be in the range between about 60 seconds and about 30 mins. In some embodiments, the time intervals between two measurements may be in the range between about 30 mins and about 2 hours. In some embodiments, the time intervals between two measurements may be in the range between about 2 hours and about 8 hours. In some embodiments, the time intervals between two measurements may be in the range between about 8 hours and about 24 hours.

In some embodiments, the sensor assembly 222 may communicate with other sensor assemblies in its vicinity. The sensor assembly may share the data wirelessly with a processing unit. In some embodiments, the sensor assembly may share data via Bluetooth, Wi-Fi, Li-Fi or other protocols for communication. In some embodiments, the sensor assembly may share data over a wired connection with a processing unit.

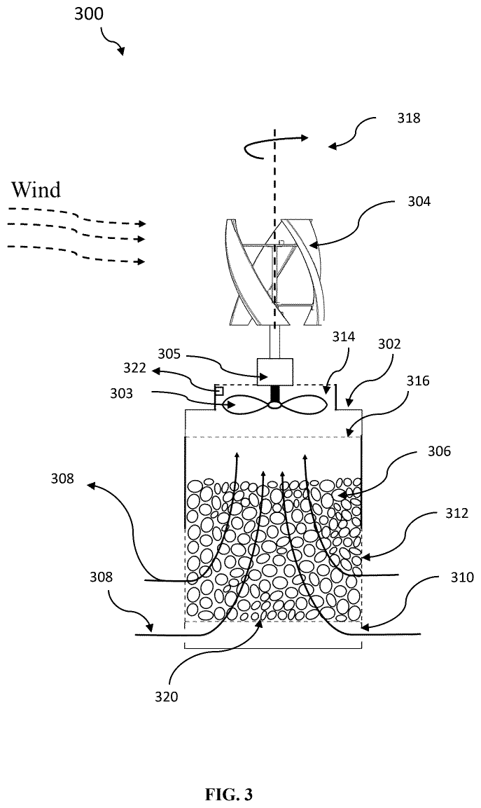

FIG. 3 shows an alternative stand-alone carbon capture system 300. The system comprises an air contactor 302 having an inlet of air (310 and 312) and an outlet of air (314); a sorbent 306 for capture of CO₂ placed inside the air contactor 302; and a wind turbine 304 coupled to a fan 303, the fan placed at the outlet 314 of the air contactor 302, wherein the rotational motion of the wind turbine (318) under the influence of wind causes the rotation of the fan which in turn causes the air flow 308 of through the sorbent 306.

The various features and variations of the air contactor 302 are same as that described in previous sections for the air contactor 202. Further, the various features and variations of the sorbent 306 are same as that described in previous sections for the sorbent 206. The air flow 308 is same as that defined in previous sections for air flow 208. The various components for the air contactor 302: air inlet 310, air outlet 314, diffused inlet 312, diffused opening 316 are the same as the corresponding components described for air contactor 202. The sensor assembly 322 is the same as that defined in previous sections for sensor assembly 222.

The wind turbine 304 is a vertical wind turbine that rotates in response to the ambient wind conditions. The torque generated by the rotation of the wind turbine is utilized to rotate a fan 303 via a coupling mechanism housed in coupler 305. In some embodiments, the axis of rotation of the wind turbine 304 may be a horizontal axis, orthogonal to the vertical axis. The wind turbine may have two blades. In some embodiments, the wind turbine has more than two blades.

In some embodiments, the blades for the wind turbine 304 comprises an array of vertical blades arranged on the circumference of a circular cross-section. The blades for the wind turbine be shaped in a helical-fashion attached to the vertical axis by means of a supporting member. The vertical wind turbine may be a bladeless wind turbine having a coupling mechanism that allows for rotation of the fan. The wind turbine 304 can be of any other shape or size as described in the art. In some embodiments, the wind turbine does not have a generator to convert mechanical energy to electrical energy.

The coupler 305 facilitates the transfer of torque generated by the rotation of wind turbine to rotate the fan 303. The coupling mechanism can either be mechanical or electrical. When the coupling mechanism is mechanical, the coupler 305 comprises a gear assembly. The gear assembly receive torque on the input side from the wind turbine 304. The gear assembly on the output side is connected on the output side to the fan 303, the gear assembly transferring torque received from the wind turbine 304 to the fan 303 causing it to rotate. In this case, the wind turbine 304 does not have a generator and the fan also does not have a motor. As a result, the losses due to conversion of mechanical energy to electrical energy and then from electrical energy to mechanical energy are prevented.

When the coupling mechanism is electrical, the coupler 305 houses a generator that converts the mechanical energy of the wind turbine into electrical energy which can then be used to power the fan 303, which in this case would have a motor to convert the input electrical energy into mechanical energy.

As shown in FIG. 3, the fan 303 is an axial fan. In some embodiments, the fan may be a centrifugal (radial) fan, a mixed flow fan combining both axial and centrifugal flow, a crossflow (tangential) fan), or a propeller fan. In some embodiments where the coupling is mechanical, the fan does not have any motor.

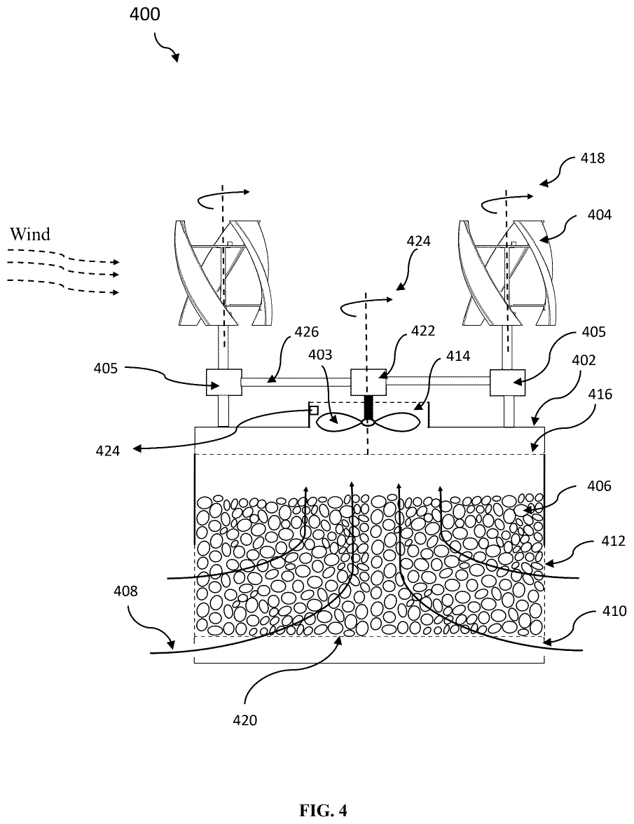

FIG. 4 shows an alternative stand-alone carbon capture system 400. The system comprises an air contactor 402 having an inlet of air (410 and 412) and an outlet of air (414); a sorbent 406 for capture of CO₂ placed inside the air contactor 402; and two wind turbines 404 coupled to a fan 403, the fan 403 placed at the outlet 414 of the air contactor 402, wherein the rotational motion of the wind turbine (418) under the influence of wind causes the rotation of the fan which in turn causes the air flow 408 of through the sorbent 406.

The various features and variations of the air contactor 402 are same as that described in previous sections for the air contactor 202. Further, the various features and variations of the sorbent 406 are same as that described in previous sections for the sorbent 206. The air flow 408 is same as that defined in previous sections for air flow 208. The various components for the air contactor 402: air inlet 410, air outlet 414, diffused inlet 412, diffused opening 416 are the same as the corresponding components described in previous sections for air contactor 202. The fan 403 is same as that described for fan 303. The wind turbine 404 is the same as that described for wind turbine 304. The sensor assembly 424 is the same as that defined in previous sections for sensor assembly 222.

As shown in the FIG. 4, two wind turbines 404 are coupled to the fan 403 in a non-co-axial fashion. The coupling mechanisms 405 and 422 facilitate the transfer of torque generated by the rotation of wind turbine to rotate the fan 403. The coupling mechanisms can either be mechanical or electrical. In some embodiments, an array of wind turbines 404 are coupled to the fan 403 via a coupler 405 and 422. In such cases additional couplers may be used.

When the coupling mechanism is mechanical, the coupler 405 comprises a gear assembly. The gear assembly is connected on the input side to the wind turbine receiving torque from the wind turbine 404. The gear assembly on the output side is connected on the output side to another coupler 422. When the coupling mechanism between couplers 405 and 422 is mechanical, the coupler 422 receives torque from the coupler 405 and transfers it to the fan 403 causing it to rotate. In this case, the wind turbine 404 does not have a generator and the fan also does not have a motor. As a result, the losses due to conversion of mechanical energy to electrical energy and then from electrical energy to mechanical energy are prevented.

When the coupling mechanism is electrical, the coupler 405 houses a generator that converts the mechanical energy of the wind turbine into electrical energy. The electrical energy from each wind turbine is integrated via the coupler 422, which is then used to power the fan 403. The fan 403 in this case would have a motor to convert the input electrical energy into mechanical energy. The fan 403 has similar features and variations as described in previous section for fan 303.

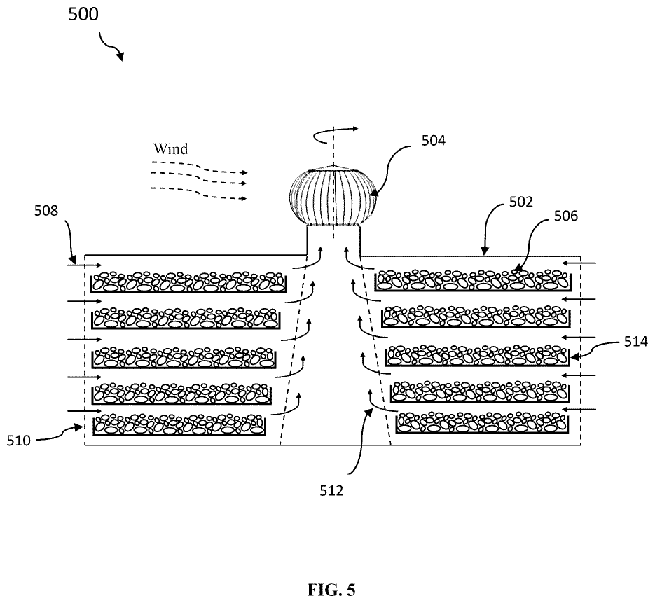

FIG. 5 shows a standalone apparatus 500 for capture of CO₂ from air, the apparatus comprising a sorbent 506 disposed within an air contactor 502 which is coupled to a wind turbine ventilator 504. The sorbent 506 is disposed within trays 514, the latter being arranged in a stacks and columns as shown. The side walls of the air contactor 502 includes openings 510 acting as an inlet for the input air 508.

The wind turbine ventilator rotates 504 in response to the flow of wind, and in the process pulls air from within the air contactor. This leads to a flow of input air 508 into the air contactor 502 from the air inlet 510. The input air 508 travels in a longitudinal direction parallel to the trays 514, and interacts with the sorbent 506 in the trays. The CO₂ in the air reacts with the sorbent 506 disposed within the trays as it towards the center of the air contactor 502. The resulting air flow 512 moves upward to the wind turbine ventilator 504 under the pressure differential caused by the rotational motion of the wind turbine ventilator as it exits the apparatus 500.

The wind turbine ventilator 504 is similar to the wind turbine ventilator 204. In some embodiments, the wind turbine ventilator 504 may be replaced with an exhaust fan coupled with a vertical axis wind turbine as shown in FIG. 3 and described in previous sections. The sorbent 506 is similar to the sorbent 106 or sorbent 206 as described in previous sections of the disclosure. The sorbent 506 may be in the form of pellets of a solid sorbent, a gel sorbent, or a semi-solid sorbent. In some embodiments, the sorbent is in the form of a loose powder filled inside the trays. In some embodiments, the sorbent 506 is a structured monolith designed to maximize the area of contact with the air while minimizing the pressure drop.

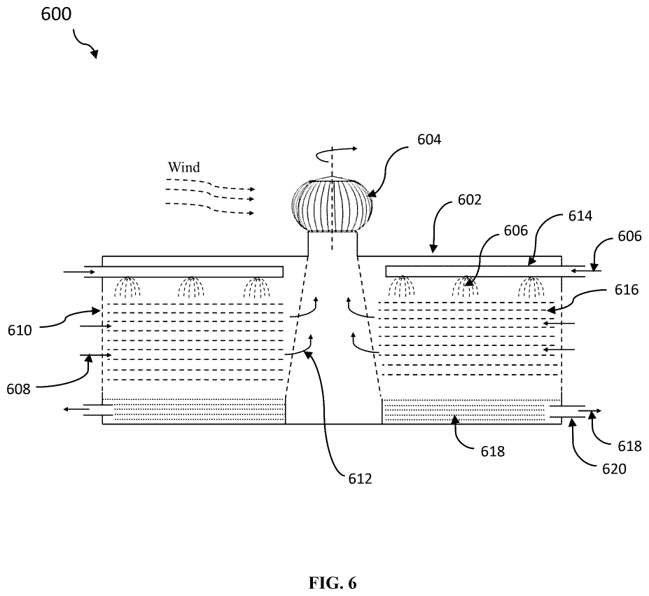

FIG. 6 shows a standalone apparatus 600 for capture of CO₂ from air, the apparatus comprising an air contactor 602 coupled to a wind turbine ventilator 604, and a liquid sorbent 606 flowing through the air contactor 602. The side walls of the air contactor 602 include openings 610 acting as an inlet for the input air 608. The apparatus 600 is a crossflow liquid sorbent-based air contactor where the air flow is driven by a wind force driven exhaust system rather than a fan.

As shown in the FIG. 6, the air contactor comprises a fill material 616. The CO₂ lean input liquid sorbent 606 enters the air contactor via a pipe 614 and is sprayed onto the fill material 616. The liquid sorbent 606 trickles down the fill material while air flows longitudinally under the effect of the pressure gradient created by the rotation of the wind turbine ventilator 604. This crossflow configuration creates an optimal contact between the liquid sorbent and the input air leading to absorption of CO₂ in the air by the liquid sorbent. The liquid sorbent loaded with CO₂ (618) collects at the bottom of the air contactor, and is extracted from the air contactor via pipe 620.

The fill material may be made of plastic, paper, ceramic or metal. The fill material may be chosen to be inert to the liquid sorbent. In some embodiments, the fill material is reactive of the liquid sorbent or the CO₂ loaded liquid sorbent. In some embodiments, the fill material is a packed bed. In some embodiments, the fill material is a rotating packed bed. The fill material may be designed to provide an optimal contact area between the liquid sorbent and the air while minimizing the pressure drop.

The liquid sorbent 606 may have chemical composition similar to that described in previous sections. The mechanism of interaction between liquid sorbent and the air is at least one of physisorption, dissolution, chemisorption, chemical reaction, catalytic conversion, reactive absorption, or mineral carbonation. The liquid sorbent may be a organic liquid, an aqueous solution, a suspension, or a slurry. The liquid sorbent 606 may be a multicomponent system will multiple mechanisms operating in synergy to capture CO₂ from the air effectively.

The air collected in the center of the air contactor (612) after interaction with the liquid sorbent is pulled upwards due to the pressure gradient created by the wind turbine ventilator. The air flow 612 eventually exits the air contactor via the exterior surface of the wind turbine ventilator.

Since many modifications, variations, and changes in detail can be made to the described embodiments of the disclosure, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the disclosure should be determined by the appended claims and their legal equivalents.

In addition, the present disclosure has been described with reference to embodiments, it should be noted and understood that various modifications and variations can be crafted by those skilled in the art without departing from the scope and spirit of the disclosure. Accordingly, the foregoing disclosure should be interpreted as illustrative only and is not to be interpreted in a limiting sense. Further it is intended that any other embodiments of the present disclosure that result from any changes in application or method of use or operation, method of manufacture, shape, size, or materials which are not specified within the detailed written description or illustrations contained herein are considered within the scope of the present disclosure.

In so far as the description above and the accompanying drawings disclose any additional subject matter that is not within the scope of the claims below, the disclosures are not dedicated to the public and the right to file one or more applications to claim such additional disclosures is reserved.

Although very narrow claims are presented herein, it should be recognized that the scope of this disclosure is much broader than presented by the claim. It is intended that broader claims will be submitted in an application that claims the benefit of priority from this application.

While this disclosure has been described with respect to at least one embodiment, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. An apparatus for carbon dioxide capture, the apparatus comprising:
an air contactor having an air inlet and an air outlet;
a sorbent for capture of CO₂ disposed inside the air contactor; and
a wind force driven exhaust system coupled to the air contactor.

2. The apparatus of claim 1, wherein the motion of the wind force driven exhaust system under the influence of wind causing the flow of air through the sorbent.

3. The apparatus of claim 1, wherein wind force driven exhaust system is a wind turbine ventilator.

4. The apparatus of claim 1, wherein the wind force driven exhaust system includes a vertical axis wind turbine coupled to an exhaust fan.

5. The apparatus of claim 1, wherein the sorbent is at least one of a solid sorbent, a liquid sorbent, a gel-based sorbent, a semi-solid, a suspension-based sorbent, or a slurry-based sorbent.

6. The apparatus of claim 1, wherein the interaction of CO₂ in the air with the sorbent includes at least one of absorption, adsorption, physisorption, chemisorption, dissolution, reactive absorption, chemical reaction, catalytic conversion, mineral carbonation, an electrochemical reaction, or combinations thereof.

7. The apparatus of claim 1, wherein the sorbent includes at least one of an amine, an amino acid, an amino acid salt, an alkali metal hydroxide, an alkaline earth metal hydroxide, an alkali metal carbonate, a transition metal hydroxide, a metal silicate, an ionic liquid, or combinations thereof.

8. A stand-alone apparatus for carbon dioxide capture comprising:
an air contactor having an air inlet and an air outlet;
a sorbent for capture of CO₂ disposed inside the air contactor; and
a wind turbine ventilator coupled to air outlet of the air contactor.

9. The apparatus of claim 8, wherein the motion of the wind turbine ventilator causes a pressure differential in the air contactor leading to the flow of air through the sorbent.

10. The apparatus of claim 8, wherein the wind turbine ventilator is configured to operate interchangeably under the effect of wind, or an electric motor.

11. The apparatus of claim 8, wherein the sorbent is at least one of a solid sorbent, a liquid sorbent, a gel-based sorbent, a semi-solid, a suspension-based sorbent, or a slurry-based sorbent.

12. The apparatus of claim 8, wherein the interaction of CO₂ in the air with the sorbent includes at least one of absorption, adsorption, physisorption, chemisorption, dissolution, reactive absorption, chemical reaction, catalytic conversion, mineral carbonation, electrochemical reaction, or combinations thereof.

13. The apparatus of claim 8, wherein the sorbent includes at least one of an amine, an amino acid, an amino acid salt, an alkali metal hydroxide, an alkaline earth metal hydroxide, an alkali metal carbonate, a transition metal hydroxide, a metal silicate, an ionic liquid, or combinations thereof.

14. A method of CO₂ capture comprising:
disposing a sorbent for CO₂ capture inside an air contactor, the air contactor including an air inlet and an air outlet; and
flowing air through the air contactor, wherein the air flow through the air contactor is caused by the motion of a wind turbine mounted on the air outlet of the air contactor.

15. The apparatus of claim 14, wherein the wind turbine is at least one of a wind turbine ventilator, a whirlybird ventilator, or a turbine exhaust.

16. The apparatus of claim 14, wherein the wind turbine is configured to operate interchangeably under the effect of wind, or an electric motor.

17. The apparatus of claim 14, wherein the wind turbine includes a vertical axis wind turbine coupled to an exhaust fan.

18. The apparatus of claim 14, wherein the sorbent is at least one of a solid sorbent, a liquid sorbent, a gel-based sorbent, a semi-solid, a suspension-based sorbent, or a slurry-based sorbent.

19. The apparatus of claim 14, wherein the interaction of CO₂ in the air with the sorbent includes at least one of absorption, adsorption, physisorption, chemisorption, dissolution, reactive absorption, chemical reaction, catalytic conversion, mineral carbonation, an electrochemical reaction, or combinations thereof.

20. The apparatus of claim 14, wherein the sorbent includes at least one of an amine, an amino acid, an amino acid salt, an alkali metal hydroxide, an alkaline earth metal hydroxide, an alkali metal carbonate, a transition metal hydroxide, a metal silicate, an ionic liquid, or combinations thereof.
